(19) United States
(12) Patent Application Publication
(10) Pub. No.: US 2015/0178567 A1
(43) Pub. Date: Jun. 25, 2015

(54) SYSTEM FOR PROVIDING GUIDE SERVICE

(71) Applicant: IMMERSIVE KOREA CO., LTD., Seoul (KR)

(72) Inventors: In Chul Baek, Seoul (KR); Jong Won Park, Seoul (KR); Youn Hoi Koo, Seoul (KR)

(21) Appl. No.: 14/405,233

(22) PCT Filed: Oct. 4, 2012
(86) PCT No.: PCT/KR2012/008049

§ 371 Date: Dec. 3, 2014

(30) Foreign Application Priority Data
Jun. 4, 2012 (KR) 10-2012-0059624

(51) Int. Cl. G06K 9/00; G06F 17/30; H04W 4/02

(52) U.S. Cl. CPC G06K 9/00671; H04W 4/026; G06F 17/30247

(57) ABSTRACT

A guide service using a mesh data generating device, a guide service providing server and a smart terminal. In particular, a device for generating mesh data for an object comprises: a marking signal sensing unit that senses a marking signal occurring in the marking for generating mesh data for each object located in a specific space; a data managing unit that sets, as position information on the object, coordinate data of a mesh data generating device, which is measured when the marking signal is sensed; and a coordinate processing unit that generates mash data for the object by using the coordinate data and height data of the object. A manager can reduce entire costs for system construction and maintenance, and a user can intuitively, conveniently, and easily obtain information on an object.

### TECHNICAL FIELD

The embodiments described herein pertain generally to a system for providing a guide service, in particular, a mesh data generating device, a method thereof, a guide service providing server, a method for providing a guide service by using the server, a smart terminal, to which the guide service is provided, and a method for a guide service through the smart terminal.

### BACKGROUND ART

Museums, exhibition halls, showrooms, art galleries, zoos, amusement parks, sculpture parks, aquariums, big shopping marts and others in Korea and foreign countries provide various methods to help visitors see/search exhibits or facilities, e.g., arranging printouts or human resources for guide, providing mobile devices, or using the RFID technology.

However, the guide methods, which are being currently provided, are problematic since efficiency is low in consideration of initial costs, and continuous costs and personnel are required for long-term operation.

FIG. 1A shows a guide system using a mobile device providing an image and audio guide for an object. Specifically, in case of the method using a human resource 11 having a profound background in an appropriate field as shown in the left drawing of FIG. 1A, the burden of personnel expenses may increase, service efficiency for a group of attendees may be lowered, and it is difficult to provide an effective service when foreigners using different foreign languages visit.

In case of the printouts for guide, it is difficult to make corrections to contents of the printouts, and since separate spaces for providing printouts in various foreign languages for global users are necessary, providing the printouts is inefficient in view of manufacturing costs.

In addition, the method providing an user with a mobile device 12 for image and audio guide for a facility or an exhibit as shown in the right drawing of FIG. 1A is disadvantageous in that the burden to introduce the mobile device is significant. The Louvre museum used billions in costs to introduce devices providing text, image and audio services in eight (8) foreign languages, and only a few large museums in Korea, e.g., the National Museum of Korea and the National Folk Museum of Korea, provide the guiding device service for several foreign languages due to the burden of costs.

FIG. 1B shows a guide system using an RFID technology. In recent, a guide system using an RFID technology 13 like a QR code and a bar code has been constructed near an exhibit or a facility as shown in the left drawing of FIG. 1B. An user can identify data information included in the code by using his/her smart phone, dedicated reader or the like to receive guide for view or exhibition.

However, the guide method using the RFID technology is inefficient since it is difficult to find out the corresponding code in case of a big exhibit, or when there are many attendees 14 around the code as shown in the right drawing of FIG. 1B, and inconvenient since an attendee should repeat a behavior for recognition by a reader, and an aged person or a child who is unfamiliar with operating the reader cannot easily operate the reader to recognize the code.

As described above, in case of using the various guide methods that are being currently provided, there are problems since the burden of initial introduction costs and management costs is high in view of the position of managers of facilities or exhibits, and convenience and efficiency are also decreased in view of the position of attendees using the methods.

In order to solve the problems, a method for downloading and using a guide application (App) through a smart phone, a tablet PC or the like, a method for receiving various contents by using an augmented reality technique as described in Korean Patent Application Publication No. 10-2012-0019158 (Title of Invention: Tour Service Providing System Based on Augmented Reality) and other methods are being promoted.

### DISCLOSURE OF THE INVENTION

### Problems to be Solved by the Invention

In order to solve the foregoing conventional problems, an example embodiment provides a novel method, in which a server manages mesh data generated for an object or facility, and an user using a smart terminal more conveniently receives a guide service through an augmented reality technique based on the mesh data.

In addition, a manager uses a mesh data generating device in accordance with an example embodiment, to easily perform a marking work for generating mesh data for an object or facility, and conveniently correct or add specific information for an object.

In addition, a guide service providing server in accordance with an example embodiment stores and manages mesh data generated in the mesh data generating device and detailed information on an object associated with the mesh data, and furthermore, accurately and effectively transmits the detailed information to a smart terminal that has made a request for the detailed information, so as to contribute to conveniently providing the entire guide service and pursuing developer's profits.

Furthermore, by establishing an environment, under which an user can use a smart terminal, to which the guide service in accordance with the example embodiment is provided, the user can more intuitively obtain detailed information or related information on a displayed object or facility, and a manager can effectively manage contents at lower costs.

### Means for Solving the Problems

In one example embodiment, a device for generating mesh data for an object, the device includes: a marking signal sensing unit that senses a marking signal occurring in the marking for generating mesh data for each object located in a specific space; a data managing unit that sets, as position information on the object, coordinate data of a mesh data generating device, which is measured when the marking signal is sensed; and a coordinate processing unit that generates mash data for the object by using the coordinate data and height data of the object.

In another example embodiment, a method for generating mesh data for an object by a mesh data generating device, the method includes: sensing a marking signal occurring in the marking for generating mesh data for each object located in a specific space; measuring coordinate data of the mesh data generating device when the marking signal is sensed; matching the coordinate data and height data of the object with each other to store the data as position information of the object; and generating mesh data of the object by using the coordinate data and the height data.

In still another example embodiment, a guide service providing server, includes: a receiving unit that receives, from a mesh data generating device generating mesh data for each object located in a specific space, the mesh data, and a request signal to request user coordinate data indicating a position of an user and detailed data for a certain object, for which the guide service will be provided, from a certain smart terminal, to which the guide service will be provided; a database that stores the mesh data and the detailed data for the object, which match the mesh data; a mesh data selecting unit that selects mesh data from a plurality of mesh data stored in the database based on the user coordinate data; and a transmitting unit that transmits the mesh data selected by the mesh data selecting unit and the detailed data corresponding to the request signal to the certain smart terminal. In this case, the mesh data are generated by using the coordinate data stored as position information of each object located in the specific space, and height data of the object, and the coordinate data are generated through marking for generating mesh data for the object in the mesh data generating device.

In still another example embodiment, a method for providing a guide service to a smart terminal through a guide service providing server, the method includes: storing mesh data received from a mesh data generating device that generates mesh data for each object located in a specific space, and detailed data for the object that match the mesh data; and transmitting the detailed data for the certain object, for which the service will be provided, to a certain smart terminal, to which the service will be provided. In this case, the mesh data are used to enable the detailed data for the certain object to be displayed in the certain smart terminal through an augmented reality technique.

In still another example embodiment, a smart terminal, to which a guide service is provided, includes: a data receiving unit that receives, from a guide service providing server, mesh data selected by the guide service providing server based on user coordinate data indicating a position of the smart terminal and detailed data for an object that match the mesh data; an object searching unit that identifies a certain object, for which the service will be provided, among a plurality of objects located in a specific space; a request signal generating unit that generates a request signal to request the detailed data for the certain object according to a result of the searching by the object searching unit; a data transmitting unit that transmits the user coordinate data and the request signal to the guide service providing server; and a technology implementing unit that operates to enable the detailed data for the certain object to be displayed on a display screen of the smart terminal through an augmented reality technique. In this case, the mesh data are generated by using coordinate data stored as position information of each object located in the specific space, and height data of the object, and the coordinate data are generated through marking for generating mesh data for the object in the mesh data generating device.

In still another example embodiment, a method for providing a guide service through a smart terminal, includes: searching a certain object, to which the service will be provided, based on mesh data received from a guide service providing server; making a request to the guide service providing server for providing detailed data for the certain object; and operating the detailed data for the certain object to be displayed on a display screen of the smart terminal through an augmented reality technique. In this case, the mesh data are generated for each object located in a specific space, and stored in the guide service providing server.

### EFFECT OF THE INVENTION

If the above-described technical means of the example embodiments, i.e., the mesh data generating device, the guide service providing server, and the smart terminal, to which the guide service is provided, are used, it is economically beneficial in that they can reduce entire costs for system construction to maximum 50%, compared to the conventional methods, and it is advantageous in that they can be easily applied to various guide service fields.

In addition, according to the mesh data generating device, which is one of the technical means of the example embodiments, mesh data for a display object can be conveniently generated, and furthermore, generation, correction, deletion and management of contents related to the object can be effectively accomplished.

In addition, since only costs for operating the guide service providing server, which is one of the technical means of the example embodiments, are necessary, a manager can easily maintain and manage the system, and an effect in reducing costs to maximum 70% can be achieved, compared to the conventional methods.

According to the smart terminal, to which the guide service is provided, and which is one of the technical means of the example embodiments, an user can intuitively, conveniently, and easily obtain information on an object by using the smart terminal, to which the augmented reality technique is applied, and more usefully and informatively see the object through the information.

### BRIEF DESCRIPTION OF THE DRAWINGS

FIG. 1A shows a guide system using a mobile device providing an image and audio guide for an object.

FIG. 1B shows a guide system using an RFID technology.

FIG. 2 is a block diagram schematically showing a guide service in accordance with example embodiments.

FIG. 3 is a block diagram schematically showing a mesh data generating device in accordance with an example embodiment.

FIG. 4 shows using the mesh data generating device in accordance with an example embodiment.

FIG. 5 shows each object located in a specific space.

FIG. 6 shows a mesh data generating process through the mesh data generating device illustrated in FIG. 4.

FIG. 7 specifically shows the mesh data generating process of FIG. 6.

FIG. 8 is a flow chart showing a method for generating mesh data in accordance with an example embodiment.

FIG. 9 is a block diagram showing a guide service providing server in accordance with an example embodiment.

FIG. 10 is a block diagram showing a smart terminal, to which the guide service is provided, in accordance with an example embodiment.

FIG. 11A to FIG. 11C show using the smart terminal, to which the guide service is provided, in accordance with an example embodiment.

FIG. 12 shows a service providing process through the smart terminal, to which the guide service is provided, as illustrated in FIG. 11A to FIG. 11C.

FIG. 13 specifically shows a process for identifying a specific object.

FIG. 14 is a flow chart showing the method for providing the guide service through the smart terminal in accordance with an example embodiment.

FIG. 15 is a flow chart showing the entire guide service in accordance with example embodiments.

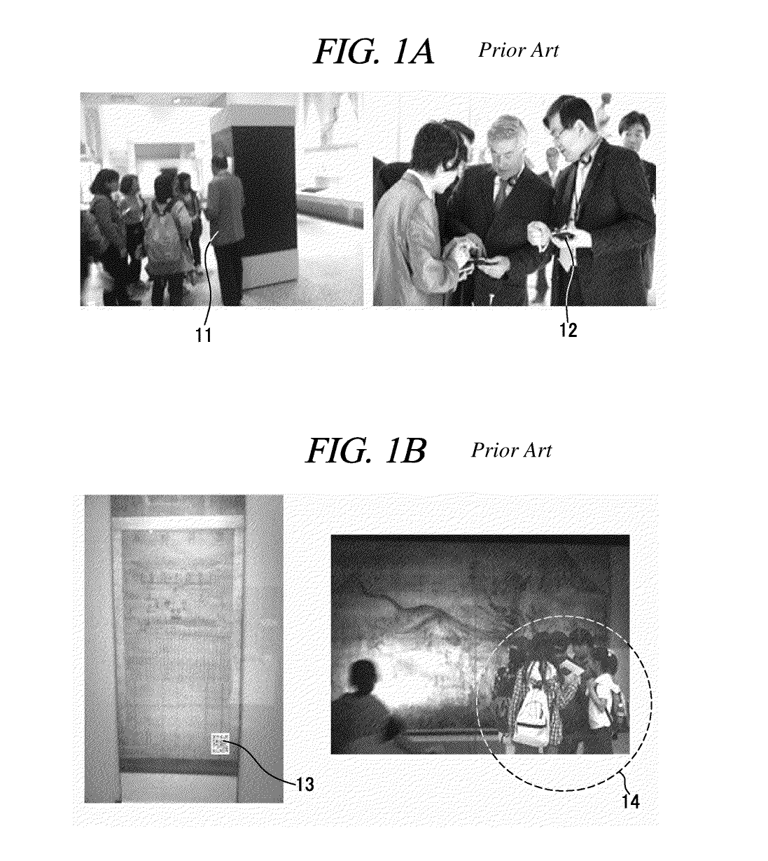

### DETAILED DESCRIPTION

Hereinafter, example embodiments will be described in detail with reference to the accompanying drawings so that inventive concept may be readily implemented by those skilled in the art. However, it is to be noted that the present disclosure is not limited to the example embodiments, but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. Further, the term “comprises or includes” and/or “comprising or including” means that one or more other components, steps, operations, and/or the existence or addition of elements are not excluded in addition to the described components, steps, operations and/or elements.

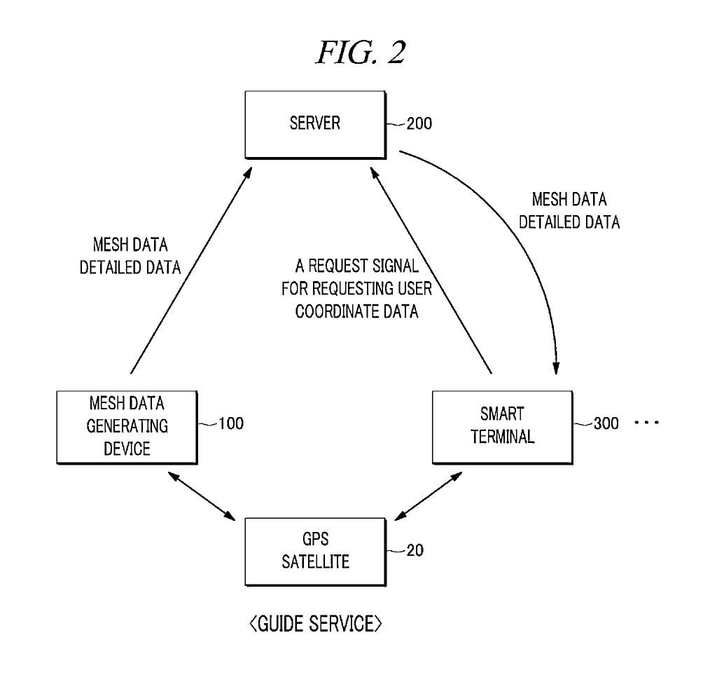

FIG. 2 is a block diagram schematically showing a guide service in accordance with example embodiments.

The guide service in accordance with example embodiments is provided by a mesh data generating device 100, a guide service providing server 200, and a smart terminal 300, to which the guide service is provided. Hereinafter, a term “guide” may include “view guide” or “sightseeing guide” in accordance with an example embodiment and “view guide” or “sightseeing guide” may be defined as the guide that assists to see all kinds of objects as well as a play, a movie, a sport game, an exhibition, etc.

In the (view or sightseeing) guide service in accordance with example embodiments, the mesh data generating device 100 and the (view or sightseeing) guide service providing server 200 may be connected to each other through a network, the (view or sightseeing) guide service providing server 200 and the smart terminal 300 used by an user may also be connected to each other through a network, and the mesh data generating device 100 and the smart terminal 300 may communicate with a GPS satellite 20.

Here, the network may be realized as a wired network such as a local area network (LAN), a wide area network (WAN) or a value added network (VAN), or any type of a wireless network such as a mobile radio communication network or a satellite communication network.

The guide service introduces a technology of a geographic information system (GIS), which is an information processing system that integrates geographic data occupying a position in a space and related attribute data with each other to process them, and provides detailed information on an object, which is requested by an user, by using position information of the user and position information of the object.

An user viewing a specific space can receive various kinds of information through the guide service. Here, the specific space is not limited to an indoor space, and means a space where view (or guide) information about an object (or an located object) is necessary, such as museums, exhibition halls, showrooms, art galleries, zoos, amusement parks, sculpture parks, aquariums and big shopping marts in Korea and foreign countries.

Additionally, as examples for the object, objects located in an art gallery may be art works made by many painters in various ways, objects located in a zoo may be animal cages divided by species of animals, and objects located in an amusement park may be rides that users can ride.

Hereinafter, configuration for providing the guide service in accordance with example embodiments is described in more detail. The guide service may be the view guide service or the sightseeing guide service in accordance with an example embodiment.

<Mesh Data Generating Device>

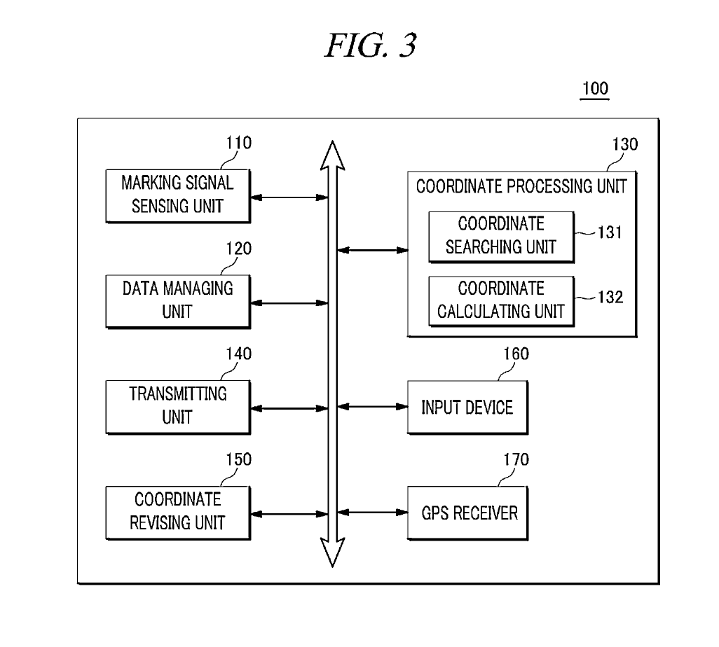

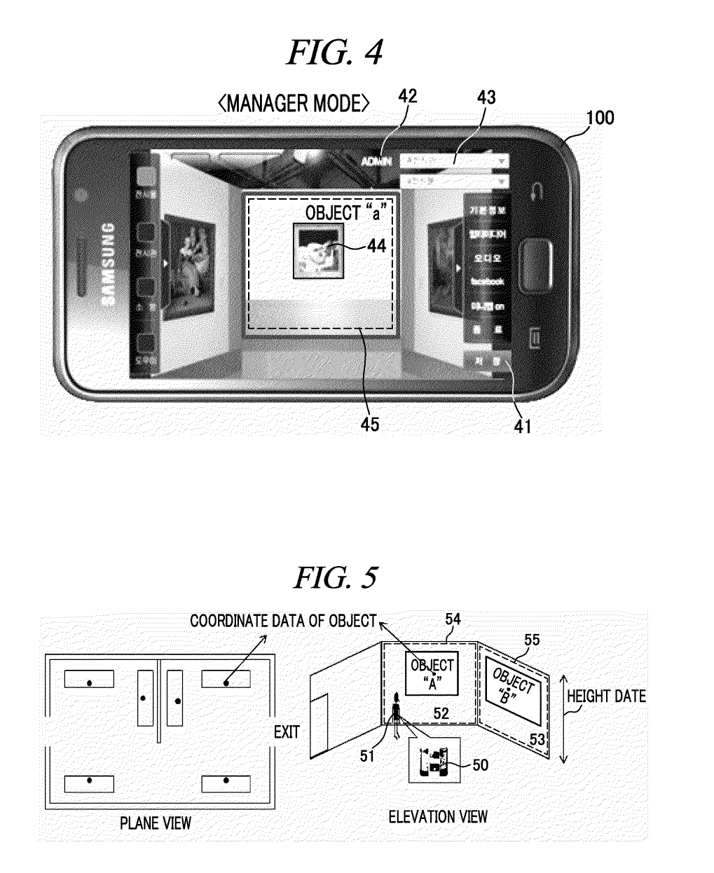

FIG. 3 is a block diagram schematically showing a mesh data generating device in accordance with an example embodiment, and FIG. 4 shows using the mesh data generating device in accordance with an example embodiment. The mesh data generating device may be used for a guide service, a view guide service or a sightseeing guide service in accordance with an example embodiment.

The mesh data generating device 100 in accordance with an example embodiment generates mesh data for an object arranged or located in a specific space, and includes a marking signal sensing unit 110, a data managing unit 120 and a coordinate processing unit 130.

The mesh data generating device 100 in accordance with an example embodiment may be a separately manufactured device, or a smart terminal like a smart phone or a table PC. In this case, the smart terminal may be equipped with an application (App) including an execution menu that can be used by a manager in a specific space, and the application may be downloaded and installed through a network or equipped by a terminal manufacturer.

If the mesh data generating device 100 is a smart phone, it may provide manager mode 42 interface as in the example illustrated in FIG. 4. The manager may generate mesh data 45 for an object “A” 44, and operate the mesh data generating device 100 to input detailed data 43 matching the mesh data.

The marking signal sensing unit 110 senses a marking signal occurring in the marking for generating mesh data for each object located in a specific space.

Here, the marking refers to a behavior of leaving a kind of a mark for recognition of a specific object, when an user desires to obtain information on the specific object by using a smart terminal, to which the guide service is provided, as described later.

For example, the marking may be accomplished in the manner that a manager pushes a certain button or a specific area of the mesh data generating device 100, or a preset motion is implemented, and is not limited to a specific method. As in the example illustrated in FIG. 4, the marking operation may be implemented in the manner that a manager pushes the “store 41” button displayed on a display of the mesh data generating device 100, whereby a marking signal occurs.

However, when the manager implements the marking, coordinate data of the mesh data generating device 100 are stored as position information of the object as described later, and accordingly, the manager needs to operate the mesh data generating device 100 such that the marking can be accomplished at a position as close as possible to the object. It is preferable to implement the marking in the state that the mesh data generating device 100 is positioned at a virtual center point for the object.

The data managing unit 120 sets and stores the coordinate data of the mesh data generating device 100 measured in the sensing of the marking signal as position information of each object. For example, the data managing unit 120 may store and manage coordinate data x, y of the mesh data generating device 100, which are measured through a GPS receiver 170 or by another method, to match position information for an object, for which marking has been implemented.

The coordinate processing unit 130 generates mesh data of each object by using the coordinate data stored and managed in the data managing unit 120 as described above, and height data of the object.

In this case, the coordinate processing unit 130 may generate mesh data of each object based on space coordinate data. The space coordinate data are stored as position information of an object in the above-described data managing unit 120, and may be generated in the form of x, y, z for each object by matching the above-described coordinate data and the height data with each other.

Here, the mesh data have a kind of boundary information as a point of interest (POI), and may be generated by the marking work implemented for each object and the input height data. In this case, it is preferable that the mesh data match each object, and include rough boundary information, and not closely and exactly measured boundary information.

Additionally, height data z of an object may be input by a manager as a distance of the object from a bottom surface, information of height from a bottom of a space where the object is located to a ceiling, or information of height of a floor, on which the object is located. The input device 160 inputting the height data may be integrated with the mesh data generating device 100, or may be a separate component, which is connected by wires or wirelessly to the mesh data generating device 100, and any input device may be used if it has a form for inputting the height data described in example embodiments. Or, the input device 160 may be connected to the guide service providing server 200, which will be described later.

Since the mesh data in example embodiments have boundary information related to a specific object as a point of interest (POI), there is no problem in identifying the specific object, for which the guide service will be provided, even though the rough height data are input.

Furthermore, the mesh data generating device 100 in accordance with an example embodiment may further include a transmitting unit 140 and a coordinate revising unit 150.

The transmitting unit 140 transmits the above-described mesh data to the guide service providing server, which will be described later, through a wired or wireless network in various conventionally known manners. In this case, when detailed data for an object are input through the input device 160 of the mesh data generating device 100, the transmitting unit 140 may transmit the detailed data matching the mesh data together with the mesh data to the guide service providing server.

Here, the detailed data may be directly input by a manager to match the mesh data through the input device 160 of the mesh data generating device 100, and include text information, picture information, image information, multimedia contents, and others.

The coordinate revising unit 150 operates so as to minimize errors between actual position information of each object and coordinate data received through the GPS receiver 170 included in the mesh data generating device 100 and stored as position information of the object.

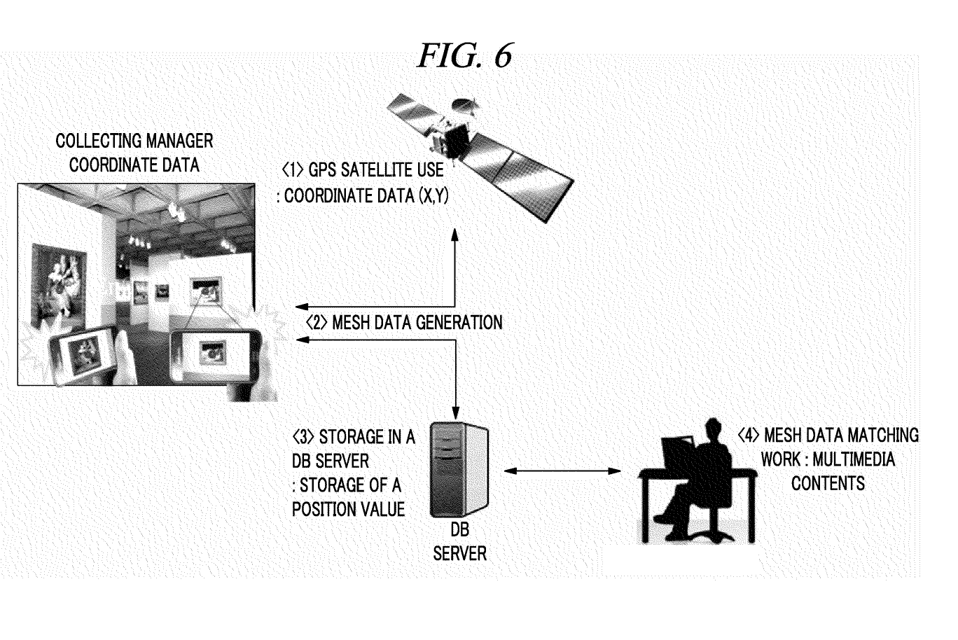

Returning to FIG. 3, the coordinate processing unit 130 may include a coordinate searching unit 131 and a coordinate calculating unit 132, which will be described with reference to the specific examples illustrated in FIG. 5 to FIG. 7.

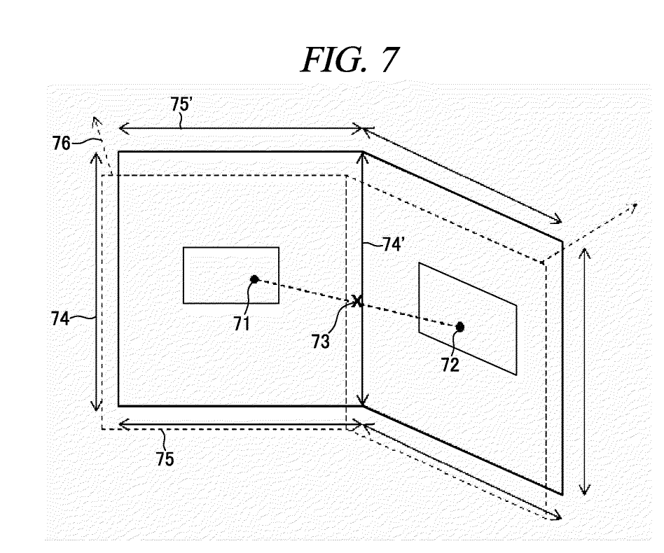

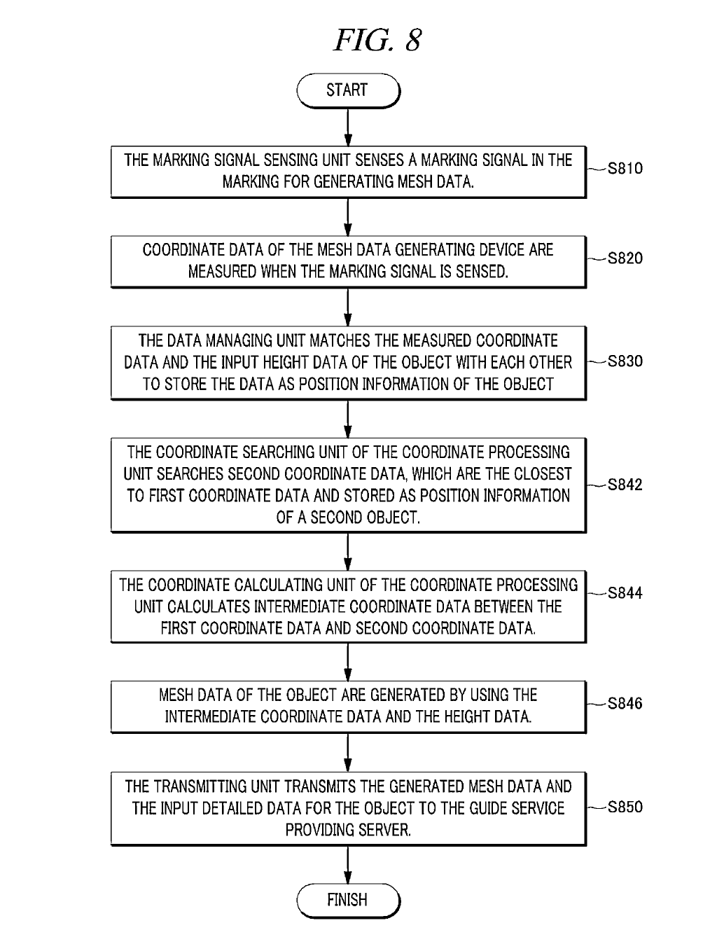

FIG. 5 shows each object located in a specific space, FIG. 6 shows a mesh data generating process through the mesh data generating device illustrated in FIG. 4, and FIG. 7 specifically shows the mesh data generating process of FIG. 6.

In the space illustrated in FIG. 5, a manager 51 may have a mesh data generating device 50, and implement a marking work for each of facilities 52, 53. When the manger 51 inputs data for a height from the bottom to the ceiling, the coordinate processing unit 130 may generate mesh data 54 for the facility A 52 and mesh data 55 for the facility B 53 by using coordinate data measured by a GPS satellite and the input height data as shown in FIG. 6. Additionally, the generated mesh data may be transmitted to the guide service providing server through the transmitting unit 140 as shown in FIG. 6, and the manager may input detailed data to match the mesh data through various means.

In this case, the operation of the coordinate searching unit 131 and the coordinate calculating unit 132 included in the coordinate processing unit 130 to generate mesh data for a facility A 71 of FIG. 7 is specifically described. For reference, the facility A 71 is referred-to as a first object, and a facility B 72 is referred to as a second object.

The data managing unit 120 may store multiple coordinate data including first coordinate data set as position information of the first object 71 and second coordinate data set as position information of the second object 72.

The coordinate searching unit 131 searches the second coordinate data 72, which are the nearest to the first coordinate data 71, from the coordinate data, and the coordinate calculating unit 132 calculates intermediate coordinate data 73 between the first coordinate data 71 and the searched second coordinate data 72.

The coordinate processing unit 130 may identify left and right boundaries 75 of the first object 71 through the intermediate coordinate data 73 and the first coordinate data 71, and a lower boundary 74 through height data of the first object 71 input by a manager. Based on the information of the boundaries, the coordinate processing unit 130 may generate mesh data 76 of the first object 71.

In addition, according to occasions, the coordinate processing unit 130 may also generate mesh data of the second object 72 based on the information of the boundaries.

Additionally, if two (2) or more second coordinate data 72, which are the nearest to the first coordinate data 71, are searched, the coordinate processing unit 130 may transmit a signal such that the display screen of the mesh data generating device 100 displays a notice to notify that the manager perform the marking once again.

Accordingly, if the mesh data generating device in accordance with an example embodiment is used, the manager can conveniently generate mesh data for an object, and furthermore, effectively generate, correct, delete and manage detailed data for the object.

In addition, since the mesh data generating device in accordance with an example embodiment generates mesh data having boundary information of an object as a point of interest (POI), an user using the smart terminal, which will be described later, can effectively search and identify a certain object when he/she desires to receive the guide service for the certain object.

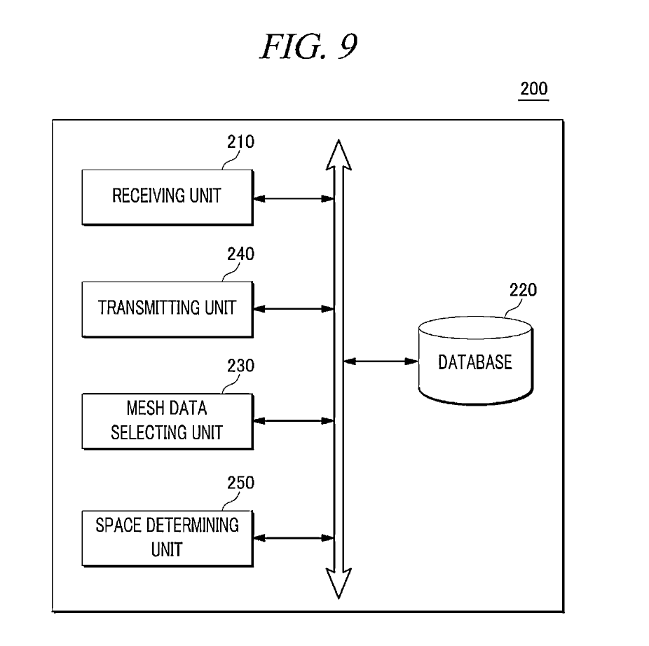

Meanwhile, a method for generating mesh data in accordance with an example embodiment is described with reference to FIG. 8. FIG. 8 is a flow chart showing the method for generating mesh data in accordance with an example embodiment.

When a manager using the mesh data generating device drives a manager mode, the marking signal sensing unit senses a marking signal occurring in the marking (S810). In this case, the marking signal occurs through the mesh data generating device operating in the manager mode, and occurs by the manager's marking behavior for generating mesh data for each object located in a certain space. Additionally, the manager's marking is preferably performed near a virtual center point for the object.

In the sensing of the marking signal, coordinate data of the mesh data generating device are measured (S820). The measuring method preferably uses a GPS receiver of the mesh data generating device or a separate high-performance GPS receiver, but other methods may be applied.

In addition, the data managing unit of the mesh data generating device matches the measured coordinate data and the height data of the object with each other, to set and store the data as position information of the object (S830). For example, measured coordinate data x, y of a facility A and input height data z of the facility A may be matched with each other to generate space coordinate data x, y, z, and the space coordinate data may be stored as position information of the facility A. In the same manner, measured coordinate data x′, y′ of a facility B and input height data z′ of the facility B may be matched with each other to generate space coordinate data x′, y′, z′, and the space coordinate data may be set and stored as position information of the facility B, which is distinguishable from the position information of the facility A. Here, the height data (z, z′) of the object may be input by the input device of the mesh data generating device.

Subsequently, the coordinate processing unit of the mesh data generating device generates mesh data of the object by using the measured coordinate data and the input height data.

Especially, the mesh data of the first object may be generated, through a process, in which the coordinate searching unit of the coordinate processing unit searches the second coordinate data the nearest to the first coordinate data (S842), and a process, in which the coordinate calculating unit of the coordinate processing unit calculates intermediate coordinate data between the first coordinate data and the second coordinate data (S844), and based on the intermediate coordinate data and the height data of the first object input by the manager (S846).

The transmitting unit of the mesh data generating device may transmit the generated mesh data to the guide service providing server (S850). If the manager inputs detailed data for the object to match the mesh data through the input device of the mesh data generating device, the transmitting unit may also transmit the input detailed data together with the above-described mesh data to the guide service providing server (S850).

According to the method for generating mesh data in accordance with an example embodiment that has been described, the manager can conveniently generate mesh data for an object through the marking behavior and input of height data. Further, since mesh data having boundary information of an object as a point of interest (POI) are generated, an user using the smart terminal, which will be described later, can effectively search and identify a certain object when he/she desires to receive the guide service for the certain object.

### Guide Service Providing Serve

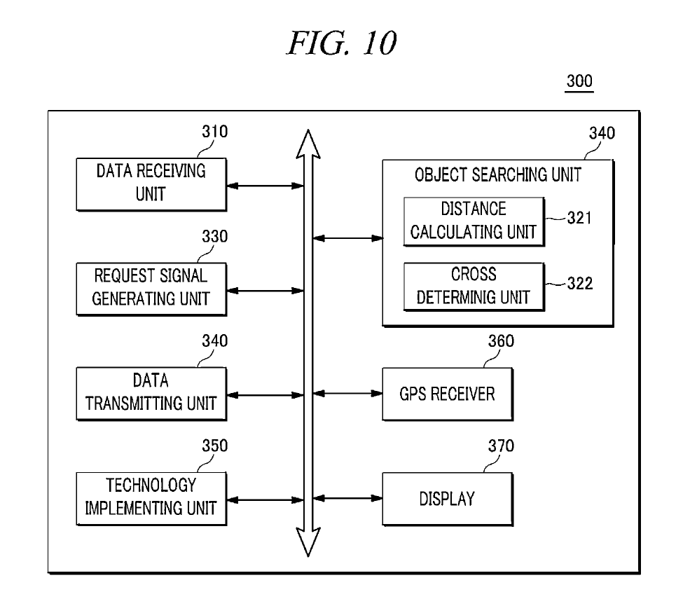

Meanwhile, the guide service providing server, which connects the above-described mesh data generating device and the smart terminal of an user, which will be described later, to each other in the guide service in accordance with the example embodiments, is described with reference to FIG. 9. FIG. 9 is a block diagram showing the guide service providing server in accordance with an example embodiment. The guide service providing server may be used for a guide service, a view guide service or a sightseeing guide service in accordance with an example embodiment.

The guide service providing server 200 is connected to the mesh data generating device and the smart terminal, to which the guide service is provided, through the above-described network, and includes a receiving unit 210, a database 220, a mesh data selecting unit 230 and a transmitting unit 240.

The receiving unit 210 receives mesh data from the above-described mesh data generating device, which generates mesh data for each object located in a specific space. In this case, the mesh data are generated by using coordinate data set as position information of each object located in a specific space, and height data of the object.

Here, it is preferable that the mesh data have a kind of boundary information as a point of interest (POI), and include rough boundary information for an object, which will be the base for the augmented reality technique accomplished in the smart terminal of an user, which will be described later. This is because when an user searches and identifies a certain object, for which the guide service in accordance with the example embodiments will be provided, by using the smart terminal, which will be described later, mesh data including exactly measured boundary information are unnecessary in view of a characteristic of an object arranged or located with a certain distance.

Additionally, the coordinate data are generated through the marking for generating mesh data for an object in the mesh data generating device as described above, and for example, may be generated through a GPS receiver equipped in the mesh data generating device.

In this case, the manager preferably performs the marking for the object after positioning the mesh data generating device near a virtual center point of the object, and this is intended to generate exact mesh data for the object through the marking.

In addition, the height data, which are received in the receiving unit 210 and necessary to generate the mesh data, may be input through the input device integrated with or connected to the mesh data generating device.

In addition, the receiving unit 210 receives user coordinate data and a request signal from a certain smart terminal, to which the guide service will be provided. Here, the user coordinate data indicate a position of the user measured through the GPS receiver of the certain smart terminal, and the request signal is intended to request detailed data for a certain object, for which the service will be provided.

The database 220 stores the above-described mesh data and the detailed data of the object matching the mesh data. In this case, the detailed data may be input by the input device of the mesh data generating device in accordance with an example embodiment, or a separate input device connected to the service providing server 200. That is, when the manager inputs the detailed data for the object, the database 220 matches the input detailed data with the mesh data to store the data. Accordingly, the manager can easily input, correct or delete the detailed data without incurring separate investment costs.

For example, if the certain space is a museum, detailed data for each object may be in a form of texts, pictures, videos and so on, and include contents such as an age of use, historical records, and uses. If the certain space is a zoo, detailed data for each animal cage may include contents such as animal habitat, feed, and characteristic parts.

The mesh data selecting unit 230 selects mesh data based on the user coordinate data from the multiple mesh data stored in the above-described database 200. In this case, the mesh data selecting unit 230 selects mesh data in an order close to the user coordinate data, and may select a preset number of mesh data.

For example, the mesh data selecting unit 230 may search mesh data close to the user coordinate data from the multiple number of the mesh data stored in the database 200, and select ten (10) mesh data from the searched mesh data in the close order.

The transmitting unit 240 transmits various data to the certain smart terminal, to which the guide service will be provided. Especially, the transmitting unit 240 transmits the mesh data selected in the mesh data selecting unit 230 and the detailed data corresponding to the request signal as described above.

Here, the request signal is generated in the certain smart terminal by using the mesh data, the user coordinate data, and directional data indicating an azimuth of the certain smart terminal, and intended to request detailed data for a certain object, to which the service will be provided.

Furthermore, the guide service providing server in accordance with an example embodiment may further include a space determining unit 250.

The space determining unit 250 automatically determines the above-described specific space, to help the transmitting unit 240 transmit mesh data for an object located or arranged in the determined space among the multiple number of the mesh data stored in the database 200.

In this case, the method allowing the space determining unit 250 to determine a space is described. The space determining unit 250 arranges the coordinate data of the mesh data stored in the database 220 in a two-dimensional coordinate plane. The two-dimensional coordinate plane may be in the form, in which an x axis increases toward a right side, and a y axis increases toward a lower portion, in order to be provided in the smart terminal. Among the arranged coordinate data of the mesh data, the coordinate data arranged in the leftmost upper portion and the coordinate data arranged in the rightmost lower portion are searched. Through the searched two (2) coordinate data, the space determining unit 250 may specify which space (e.g., art gallery A or B) is indicated by the corresponding space.

By using the guide service providing server in accordance with an example embodiment that has been described, operation costs can be significantly saved, and the manager can easily maintain and manage information (mesh data and detailed data) on an object.

### Smart Terminal, to Which the Guide Service will be Provided

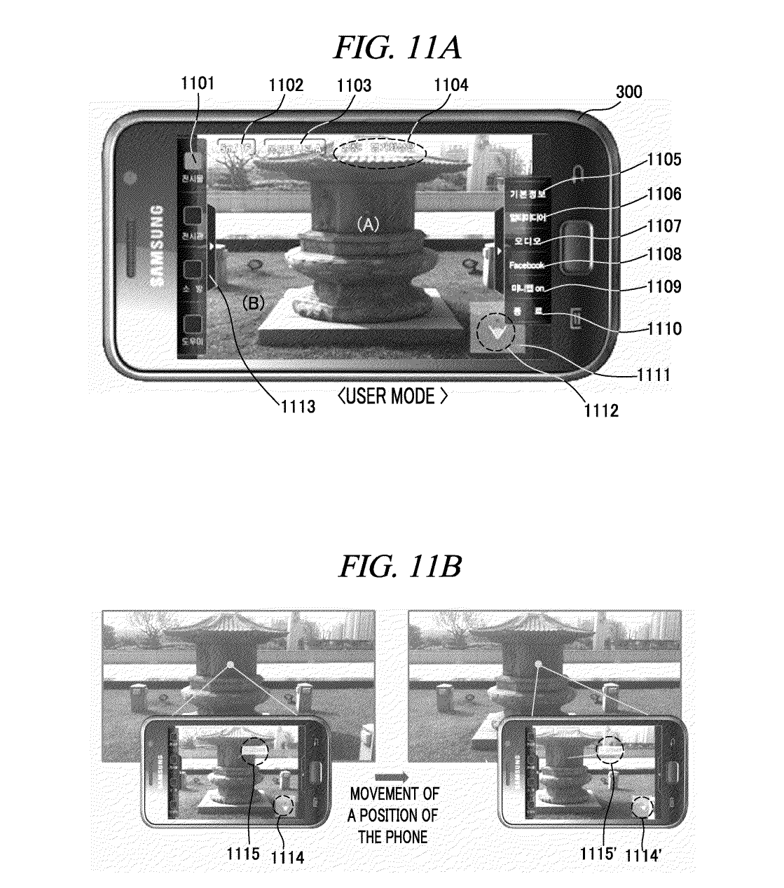

Meanwhile, the smart terminal of an user, which uses the mesh data generated in the mesh data generating device for providing the guide service in accordance with the example embodiments as described above and is connected to the above-described guide service providing server, is described with reference to FIG. 10. The smart terminal may be used for a guide service, a view guide service or a sightseeing guide service in accordance with an example embodiment.

FIG. 10 is a block diagram showing the smart terminal, to which the guide service in accordance with an example embodiment is provided.

The smart terminal 300, to which the guide service in accordance with an example embodiment is provided, includes a data receiving unit 310, an object searching unit 320, a request signal generating unit 330, a data transmitting unit 340, and a technology implementing unit 350.

Here, the smart terminal 300 may be a terminal having a PC-level process performance capable of rapidly processing complicated calculations and a performance capable of representing full HD videos and graphic and sound effects, and may conduct high-speed data communication such as a radio Internet function and a Bluetooth function and provide other functions such as GPS, a camera, a digital compass and a proximity sensor. The smart terminal 300 may be carried by an individual user, like a smart phone, a tablet PC, and others, and equipped with an application for providing the guide service in accordance with the example embodiments. This application may be equipped in advance at the time of manufacture of the terminal or downloaded and installed through a network. Although the smart terminal 300 may be separately manufactured and provided by the manager, it is preferable to use a terminal of an user for cost reduction.

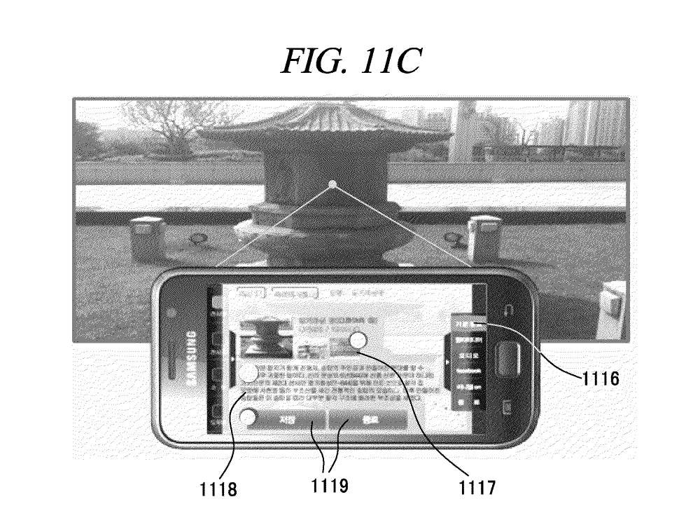

When the above-described application is executed in the smart terminal 300, to which the guide service in accordance with an example embodiment is provided, an user can receive the guide service under an user mode interface (UI) environment construed as shown in FIG. 11A to FIG. 11C. FIG. 11A to FIG. 11C show using the smart terminal, to which the guide service in accordance with an example embodiment is provided.

With reference to FIG. 11A, an object A and an augmented reality B part appear on the display screen of the smart terminal 300 at the same time.

In this case, a menu bar 1101 indicating a currently selected mode, and a slide button 1113 for conversion of modes appear on the left side of the display screen. The upper portion of the display screen displays information on a distance between an object and a floor 1102 where the user is being currently positioned, information on an area name 1103 for a specific space of an exhibition hall, and information on a name 1104 of an object.

Subsequently, the right side of the display screen displays a basic information tab 1105 for the object A, and when the user generates an input signal to the basic information tab 1105, text- and image-based basic information may appear on the display screen. A multimedia tab 1106 activates video contents information for the object A. An audio tab 1107 may activate audio contents information for the object A, to contribute to a blind person or an aged person. An SNS connection tab 1107 enables connection to social network services such as Facebook and Twitter. A mini-map tab 1109 makes a mini-map 1111 displayed on the right lower portion of the display screen on/off. In this case, when the mini-map 1111 is on, a direction, toward which the user is currently looking through the smart terminal 300, a position of the user and a position 1112 of a peripheral object are displayed on the mini-map 1111. A finish tab 1110 can be used when the guide service is desired to be finished.

With reference to FIG. 11B, it can be identified that even if the smart terminal 300 is somewhat moved, the guide service is provided for an object by using an algorithm, which will be described later. When comparing changes before and after the movement of the smart terminal 300, it is identified that changes occur in a direction 1114, 1114′, toward which the user is looking, on the mini-map, and a name 1115, 1115′ tag portion of a certain object, for which the guide service is provided.

With reference to FIG. 11C, when an user pushes the basic information tab 1116, a new window appears overlapping over the display screen, which is implementing augmented reality, and the new window displays detailed data for an object including image information 1117 and text information 1117, and a storage/finish button 1119. When a signal is applied to the storage button, the displayed detailed data may be stored in a post-it form on an internal memo board, and when a signal is applied to the finish button, the overlapping new window disappears.

Returning to FIG. 10, the data receiving unit 310 receives various data from the guide service providing server, and especially, mesh data selected based on user coordinate data indicating a position of the smart terminal 300 in the guide service providing server and detailed data for an object, which match the mesh data.

The object searching unit 320 identifies a certain object, for which the guide service will be provided, among multiple objects located in a specific space. In order to identify the certain object, the object searching unit 320 may use mesh data, user coordinate data and directional data indicating an azimuth of the smart terminal 300.

In this case, the mesh data are generated by using coordinate data stored as position information of each object located in a specific space, and height data of the object. The coordinate data are generated through the marking using the mesh data generating device in accordance with an example embodiment, and the marking means a behavior for generating mesh data for an object. The height data may be input through the input device of the mesh data generating device, and match the above-described coordinate data.

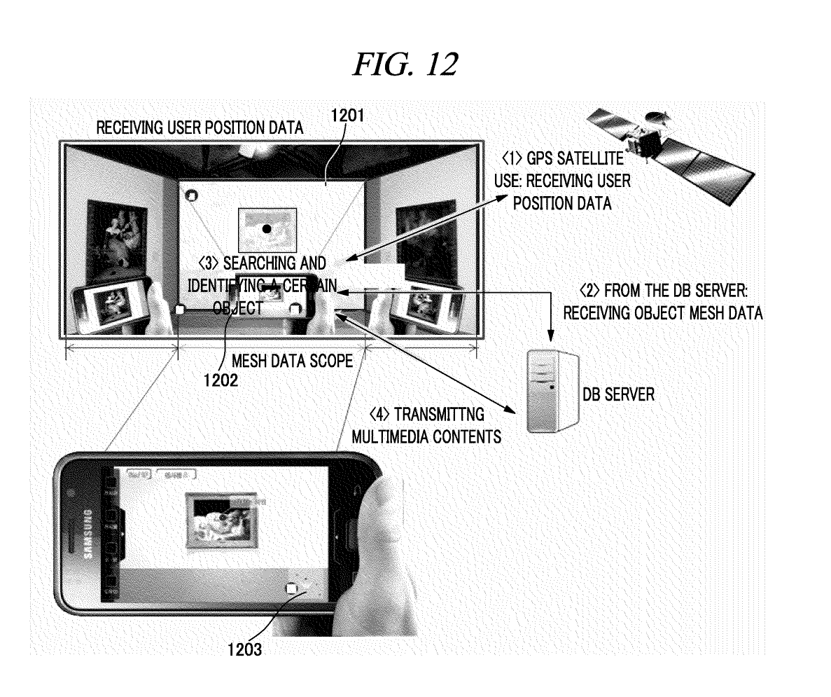

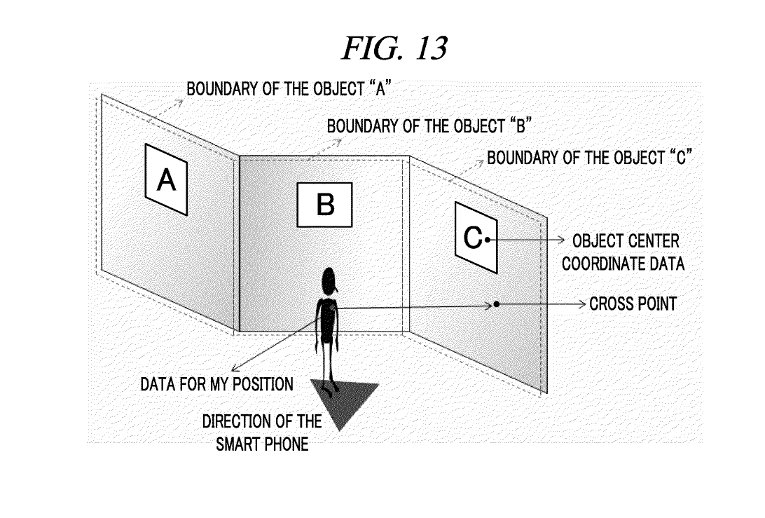

Specifically, a distance calculating unit 321 and a cross determining unit 322 of the object searching unit 320 operate to identify the certain object, for which the guide service will be provided, and the operation is described with reference to FIG. 12 and FIG. 13. FIG. 12 shows a service providing process through the smart terminal, to which the guide service is provided as illustrated in FIG. 11A to FIG. 11C, and FIG. 13 specifically shows the process for identifying the certain object according to FIG. 12.

With reference to FIG. 12, the smart terminal 1201 of an user receives current coordinate data (position data) from a GPS satellite. The smart terminal 1201 receives mesh data from the guide service providing server to search a certain object, for which the guide service will be provided. In this case, the mesh data to be received are mesh data selected in the guide service providing server based on the coordinate data received from the GPS satellite. The smart terminal 1201 searches and identifies a certain object, for which information an user desires to obtain, by using the coordinate data and the received mesh data 1201, and transmits a request signal to request information or detailed data for the certain object to the guide service providing server. The user can receive the service through the mini-map 1203 on the display screen.

The distance calculating unit 321 calculates a distance between the certain object and the smart terminal through the mesh data selected based on the user coordinate data, and the user coordinate data. In case of FIG. 13, the guide service providing server may select three (3) mesh data including boundary information for the facilities (a), (b) and (c) based on the user coordinate data and transmit the mesh data to the smart terminal of the user. The distance calculating unit 321 may calculate distances between the three (3) objects and the smart terminal by using center coordinate data of the three (3) user objects, which can be obtained from each of the user coordinate data and the three (3) mesh data.

The cross determining unit 322 determines whether a virtual straight line generated by using the directional data indicating an azimuth of the smart terminal and the results of the calculation by the distance calculating unit 321, and the selected mesh data cross with each other. In this case, the directional data may be measured through a terrestrial magnetic sensor equipped in the smart terminal. In FIG. 13, the cross determining unit 322 identifies a certain object, for which information an user desires to obtain, based on whether the mesh data for each of the facilities (a), (b) and (c), and the generated virtual straight line cross with each other. In FIG. 13, since the cross point is generated from the relation between the object (c) and the mesh data, the cross determining unit 322 can identify the object as a certain object, for which the guide service will be provided.

In addition, the request signal generating unit 330 generates a request signal according to the result of the searching by the object searching unit 320, and the request signal is intended to request detailed data for the certain object, for which the guide service will be provided.

As described above with reference to FIG. 11C, when the user pushes the basic information tab 1116, a new window appears overlapping over the display screen that is implementing augmented reality. The request signal is intended to request detailed data for a certain object including image information 1117 and text information 1118 to be displayed on the new window.

Additionally, the request signal generating unit 330 may generate a request signal to request detailed data for an object corresponding to the mesh data crossing with the virtual straight line as described above. That is, due to the request signal generated by the request signal generating unit 330, the detailed data for the certain object may be displayed on the display screen.

If the mesh data crossing with the above-described virtual straight line are plural in number, the request signal generating unit 330 may generate a request signal for requesting detailed data for an object corresponding to mesh data, which are the closest to the user coordinate data, among the multiple mesh data. That is, if three (3) objects are arranged in a direction, toward which an user having the smart terminal 300 is looking, detailed data for only an object being the closest to the user among the three (3) objects may be displayed on the display screen due to the request signal generated by the request signal generating unit 330.

The data transmitting unit 340 transmits various data to the guide service providing server, and especially, user coordinate data indicating a position of the smart terminal 300 and the above-described request signal. In this case, the user coordinate data may be measured through the GPS receiver 360 of the smart terminal 300 in accordance with an example embodiment, but is not specifically limited.

The technology implementing unit 350 operates such that the detailed data for the certain object, for which the guide service will be provided, are displayed on the display screen of the smart terminal 300 through the augmented reality technique. In this case, the method for implementing the augmented reality technique is not limited to a certain method, and any conventionally known method may be applied.

Here, the display screen is connected to the display unit 370 and displays the detailed data provided by the technology implementing unit 350. Touch input or the like capable of implementing an operation to display data, and furthermore, an operation to receive input by a user may be applied to the display screen, and materials for the display screen are not limited to LCD, LED, OLED, and others.

By using the smart terminal, to which the guide service in accordance with an example embodiment is provided, an user can intuitively, conveniently, and easily obtain information on an object through the augmented reality technique, and more usefully and informatively see objects or exhibits.

Furthermore, by using the smart terminal, a manager does not need to have separate guide instruments, and since information management is also by the above-described guide service providing servicer, an effect in reducing costs can be achieved.

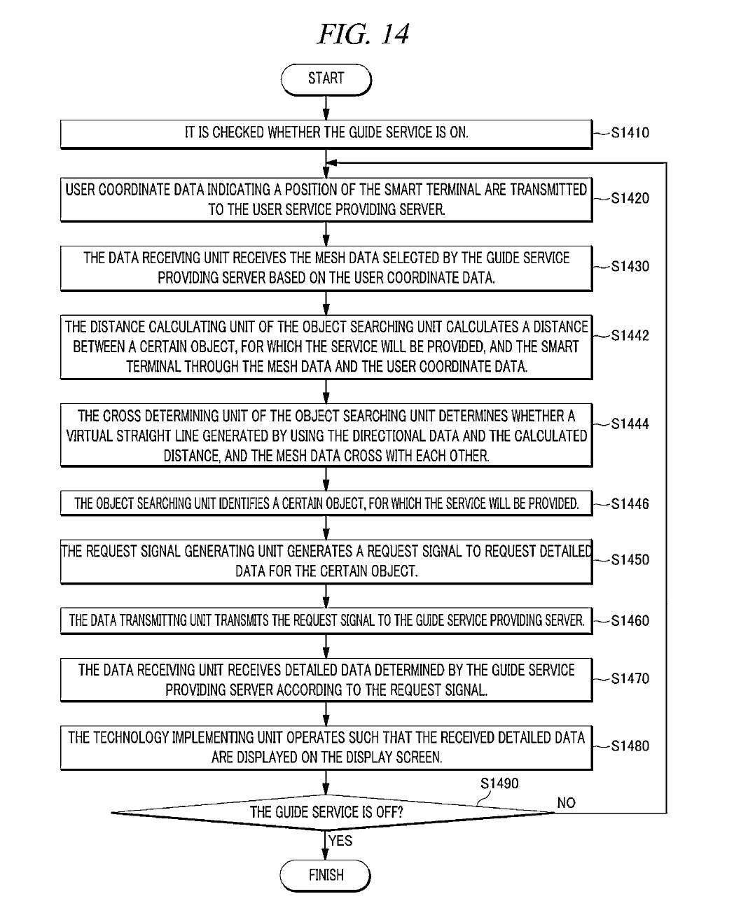

Meanwhile, a method for providing the guide service through the smart terminal in accordance with an example embodiment is specifically described with reference to FIG. 14. FIG. 14 is a flow chart showing the method for providing the guide service through the smart terminal in accordance with an example embodiment.

If the smart terminal is equipped with an application for providing the guide service, an user executes the application to start the guide service. That is, it is checked whether the guide service is in the ON state (S1410), and in case of the ON state, the next process is proceeded with.

The smart terminal transmits the user coordinate data indicating a position of the smart terminal (a position of the user) to the guide service providing server (S1420).

Subsequently, the data receiving unit of the smart terminal receives the mesh data selected based on the user coordinate data in the guide service providing server (S1430).

Thereafter, the object searching unit of the smart terminal searches and identifies a certain object, for which the guide service will be provided, by using the user coordinate data and the mesh data received from the server.

Specifically, the distance calculating unit of the object searching unit calculates a distance between the smart terminal and the object corresponding to the received mesh data based on the user coordinate data (S1442). The cross determining unit of the object searching unit determines whether a virtual straight line generated by using the directional data and the distance calculated by the distance calculating unit, and the received mesh data cross with each other (S1444). The distance calculating unit and the cross determining unit interwork with each other, and the object searching unit identifies the object corresponding to the mesh data having a cross point as the certain object (S1446).

The request signal generating unit of the smart terminal generates a request signal for requesting the detailed data for the identified certain object from the guide service providing server (S1450).

Thereafter, the data transmitting unit transmits the request signal to the guide service providing server (S1460), and the data receiving unit receives the detailed data determined by the guide service providing server according to the request signal (S1470). The technology implementing unit of the smart terminal operates such that the received detailed data are displayed on the display screen through the augmented reality technique (S1480).

The smart terminal checks whether the guide service is in the OFF state (S1490), and if the guide service is still in the ON state, the smart terminal measures the user coordinate data once again (S1420), to implement preparatory works for searching and identifying a next certain object.

Through the whole processes operating in real time by a certain processor, the user can intuitively obtain various information on an object through the augmented reality technique implemented in his/her smart terminal.

### Guide Service System

The guide service in accordance with the example embodiments is achieved by the mesh data generating device 100, the guide service providing server 200, and the smart terminal 300, to which the guide service is provided, as described above. The guide service may be the view guide service or the sightseeing guide service in accordance with an example embodiment.

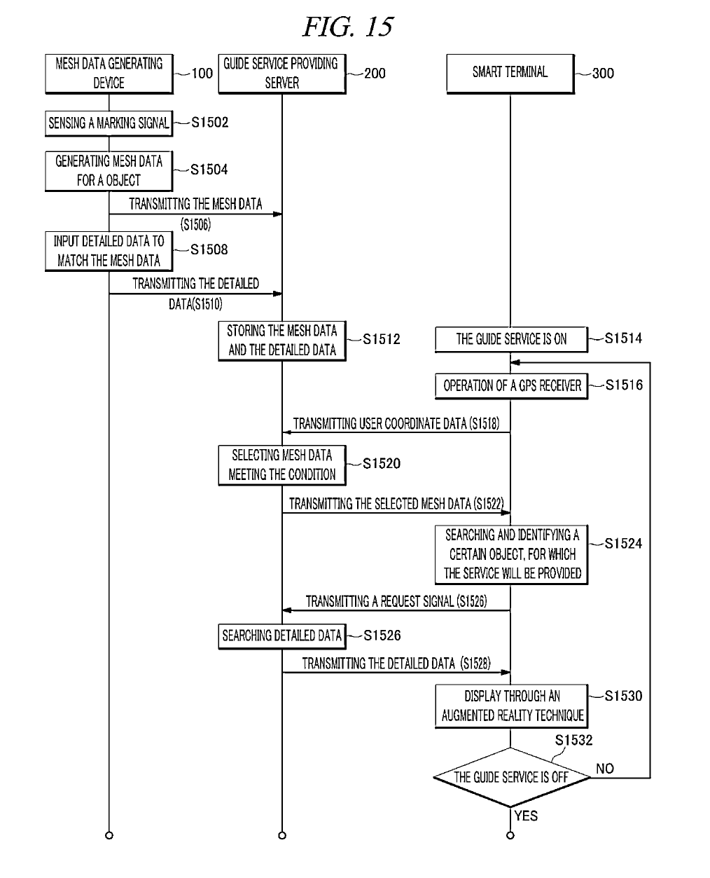

The whole service processes are schematically described with reference to FIG. 15. FIG. 15 is a flow chart showing the whole guide service in accordance with the example embodiments.

The mesh data generating device 100 senses a marking signal mostly generated by a manager (S1502) to generate mesh data for an object (S1504), and transmits the generated mesh data to the guide service providing server 200 (S1506). The mesh data generating unit 100 also transmits detailed data mostly input by a manager to match the mesh data to the guide service providing server 200 (S1508, S1510). However, the detailed data do not have to be input by the mesh data generating device 100.

The guide service providing server 200 stores the mesh data and the detailed data received from the mesh data generating unit 100 (S1512), and selects a preset number of mesh data from the stored mesh data based on the user coordinate data received from the smart terminal 300 (S1514). The guide service providing server 200 transmits the selected mesh data to the smart terminal 300 (S1522), and receives a request signal from the smart terminal 300 (S1526). The guide service providing server 200 undergoes a process for searching detailed data corresponding to the received request signal (S1528) and transmitting the searched detailed data to the smart terminal 300 (S1530).

The smart terminal 300, to which the guide service is provided, checks whether the smart terminal 300 is in the guide service mode, to implement the process described hereinafter in case of ON (S1514). The GPS receiver of the smart terminal 300 operates to receive the user coordinate data (S1516), and transmits the received user coordinate data to the guide service providing server 200 (S1518). The smart terminal 300 receives the mesh data selected by the guide service providing server 200 (S1522), and searches and identifies a certain object, for which the service will be provided. The smart terminal 300 transmits a request signal to request detailed data for the identified certain object to the guide service providing server 200 (S1526), and receives detailed data corresponding to the request signal (S1530). After the received detailed data are displayed to the user through the augmented reality technique (S1532), the smart terminal 300 checks whether the smart terminal 300 is in the guide service mode once again (S1534).

As described above, the mesh data generating method in accordance with an example embodiment includes: a process for sensing a marking signal occurring in the marking for generating mesh data for each object located in a specific space; a process for measuring coordinate data of a mesh data generating device when the marking signal is sensed; a process for matching the coordinate data and height data of the object with each other to store the data as position information of the object; and a process for generating mesh data of the object by using the coordinate data and the height data.

In addition, the method for providing the guide service to the smart terminal through the guide service providing server in accordance with an example embodiment includes: a process for storing mesh data received from a mesh data generating device that generates mesh data for an object located in a specific space, and detailed data for the object that match the mesh data; and a process for transmitting the detailed data for the certain object, for which the service will be provided, to the certain smart terminal, to which the service will be provided. In this case, the mesh data are used to enable the detailed data for the certain object to be displayed in the certain smart terminal through the augmented reality technique.

In addition, the method for providing the guide service through the smart terminal in accordance with an example embodiment includes: a process for searching the certain object, for which the service will be provided, based on the mesh data received from the guide service providing server; a process for making a request to the guide service providing server to request that the detailed data for the certain object be provided; and a process for enabling the detailed data for the certain object to be displayed on the display screen of the smart terminal through the augmented reality technique. In this case, the mesh data is generated for each object located in a specific space and stored in the guide service providing server.

By using the guide service accomplished through the foregoing processes by a certain processor in accordance with the example embodiments, a manager can save system construction costs and maintenance costs, and an user can intuitively, conveniently and easily obtain information on an object by using the smart terminal, to which the augmented reality technique is applied.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

1. A device for generating mesh data for an object, the device comprising:
a marking signal sensing unit that senses a marking signal occurring in the marking for generating mesh data for each object located in a specific space;
a data managing unit that sets, as position information on the object, coordinate data of a mesh data generating device, which is measured when the marking signal is sensed; and
a coordinate processing unit that generates mash data for the object by using the coordinate data and height data of the object.

2. The device for generating mesh data as claimed in claim 1,
wherein the coordinate processing unit comprises:
a coordinate searching unit that searches second coordinate data, which are the closest to first coordinate data set as position information of a first object, and set as position information of a second object, among the coordinate data stored in the data managing device; and
a coordinate calculating unit that calculates intermediate coordinate data between the first coordinate data and the second coordinate data, and
mesh data of the first object are generated based on the intermediate coordinate data and the height data of the first object.

3. The device for generating mesh data as claimed in claim 1,
wherein the data managing unit sets space coordinate data generated by matching the coordinate data and the height data with each other for each object as the position information of the object, and
the coordinate processing unit generates the mesh data of the object based on the space coordinate data.

4. The device for generating mesh data as claimed in claim 1, the device further comprising a transmitting unit that transmits the mesh data to a guide service providing server.

5. The device for generating mesh data as claimed in claim 4,
wherein the transmitting unit transmits detailed data for the object, which are input through an input device of the mesh data generating device, to the guide service providing server, and
the detailed data match the mesh data.

6. The device for generating mesh data as claimed in claim 1, the device further comprising a coordinate revising unit that minimizes errors between actual position information of the object and the coordinate data received through a GPS receiver included in the mesh data generating device and stored as the position information of the object.

7. A method for generating mesh data for an object by a mesh data generating device, the method comprising:
sensing a marking signal occurring in the marking for generating mesh data for each object located in a specific space;
measuring coordinate data of the mesh data generating device when the marking signal is sensed;
matching the coordinate data and height data of the object with each other to store the data as position information of the object; and
generating mesh data of the object by using the coordinate data and the height data.

8. The method for generating mesh data as claimed in claim 7,
wherein the generating of the mesh data comprises:
searching second coordinate data, which are the closest to first coordinate data set as position information of a first object, and set as position information of a second object; and
calculating intermediate coordinate data between the first coordinate data and the second coordinate data, and
mesh data of the first object are generated based on the intermediate coordinate data and the height data of the first object.

9. The method for generating mesh data as claimed in claim 7, the method further comprising transmitting the mesh data and detailed data for the object, which are input through an input device of the mesh data generating device and match the mesh data, to a guide service providing server.

10. A guide service providing server, comprising:
a receiving unit that receives, from a mesh data generating device generating mesh data for each object located in a specific space, the mesh data, and a request signal to request user coordinate data indicating a position of an user and detailed data for a certain object, for which the view guide service will be provided, from a certain smart terminal, to which the guide service will be provided;
a database that stores the mesh data and the detailed data for the object, which match the mesh data;
a mesh data selecting unit that selects mesh data from a plurality of mesh data stored in the database based on the user coordinate data; and
a transmitting unit that transmits the mesh data selected by the mesh data selecting unit and the detailed data corresponding to the request signal to the certain smart terminal,
wherein the mesh data are generated by using the coordinate data stored as position information of each object located in the specific space, and height data of the object, and
the coordinate data are generated through marking for generating mesh data for the object in the mesh data generating device.

11. The guide service providing server of claim 10,
wherein the receiving unit receives the detailed data for the object from the mesh data generating device, and
the detailed data match the mesh data.

12. The guide service providing server of claim 10,
wherein the mesh data selecting unit selects mesh data in an order close to the user coordinate data, and selects a predetermined number of mesh data.

13. The guide service providing server of claim 10,
wherein the request signal is generated in the certain smart terminal by using the mesh data, the user coordinate data and directional data indicating an azimuth of the certain smart terminal.

14. The guide service providing server of claim 10, further comprising a space determining unit, in which when each of the coordinate data of the mesh data stored in the database is arranged in a two-dimensional plane, the space determining unit automatically determines the specific space through the coordinate data arranged in the leftmost upper portion and the coordinate data arranged in the rightmost lower portion.

15. A method for providing a guide service to a smart terminal through a guide service providing server, the method comprising:
storing mesh data received from a mesh data generating device that generates mesh data for each object located in a specific space, and detailed data for the object that match the mesh data; and
transmitting the detailed data for the certain object, for which the service will be provided, to a certain smart terminal, to which the service will be provided,
wherein the mesh data are used to enable the detailed data for the certain object to be displayed in the certain smart terminal through an augmented reality technique.

16. A smart terminal, to which a guide service is provided, comprising:
a data receiving unit that receives, from a guide service providing server, mesh data selected by the guide service providing server based on user coordinate data indicating a position of the smart terminal and detailed data for an object that match the mesh data;
an object searching unit that identifies a certain object, for which the service will be provided, among a plurality of objects located in a specific space;
a request signal generating unit that generates a request signal to request the detailed data for the certain object according to a result of the searching by the object searching unit;
a data transmitting unit that transmits the user coordinate data and the request signal to the guide service providing server; and
a technology implementing unit that operates to enable the detailed data for the certain object to be displayed on a display screen of the smart terminal through an augmented reality technique,
wherein the mesh data are generated by using coordinate data stored as position information of each object located in the specific space, and height data of the object, and
the coordinate data are generated through marking for generating mesh data for the object in the mesh data generating device,

17. The smart terminal of claim 16,
wherein the object searching unit uses the selected mesh data, the user coordinate data and directional data indicating an azimuth of the smart terminal.

18. The smart terminal of claim 16,
wherein the object searching unit comprises:
a distance calculating unit that calculates a distance between the certain object and the smart terminal through the selected mesh data and the user coordinate data; and
a cross determining unit that determines whether a virtual straight line generated by using the directional data indicating an azimuth of the smart terminal and the result of the calculation by the distance calculating unit, and the mesh data cross with each other,
wherein the certain object is identified according to the result of the determination by the cross determining unit.

19. The smart terminal of claim 18,
wherein the request signal generating unit generates a request signal to request detailed data for an object, which correspond to the mesh data crossing with the virtual straight line.

20. The smart terminal of claim 18,
wherein the request signal generating unit generates a request signal to request detailed data for an object, which correspond to mesh data closest to the user coordinate data among the mesh data crossing with the virtual straight line.

21. A method for providing a guide service through a smart terminal, comprising:
searching a certain object, to which the service will be provided, based on mesh data received from a guide service providing server;
making a request to the guide service providing server for providing detailed data for the certain object; and
operating the detailed data for the certain object to be displayed on a display screen of the smart terminal through an augmented reality technique,
wherein the mesh data are generated for each object located in a specific space, and stored in the guide service providing server.
